(19) United States
(12) Patent Application Publication
(10) Pub. No.: US 2010/0272864 A1
(43) Pub. Date: Oct. 28, 2010

(54) Edible adhesive tape

(76) Inventor: Adam Philip Schreiner, Hunter, ND (US)

Correspondence Address: Brainstorm Consulting, LLC, 3730 Taylor Street South, FARGO, ND, 58104, US

(21) Appl. No.: 12/386,717

(22) Filed: Apr. 22, 2009

(51) Int. Cl. A23L 1/10

(52) U.S. Cl. 426/93

(57) ABSTRACT

An edible adhesive tape which can be used to hold food products together as they are being consumed, to provide a decoration or garnish to a food product, or to add flavor to a food product.

### FIELD OF INVENTION

This invention pertains to an edible adhesive tape that can be used in the assembly, decoration, and flavoring of food products.

### BACKGROUND

Items such as sandwiches, tacos, and pitas were developed to allow people to eat food with their fingers without getting messy. The breads or tortillas used in these products are meant to wrap or otherwise encapsulate the foods contained within, separating potentially moist and sticky foods from human hands. Unfortunately, if the food product is poorly assembled, the bread or tortilla wrapper can separate or slide to one side, allowing food to fall out. Even a properly assembled sandwich or taco can begin to fall apart when it is being eaten.

Some restaurants have attempted to solve this problem by wrapping their sandwiches and tortilla products in paper to contain the product and hold it together. The paper wrapper can be torn away in sections as the product is consumed. Unfortunately, tearing away or unwrapping the paper to reveal the food item can be an awkward process, and can cause additional problems and mess.

What is needed in the art is an edible means of securing and holding these food items together as they are being consumed.

### SUMMARY

Accordingly, it is one objective of the present invention to describe an edible adhesive tape which can be used to hold food products together or in place as they are being consumed.

It is another objective of the present invention to describe an edible adhesive tape which can be used as a decoration or garnish on a variety of food products.

It is yet another object of the present invention to describe an edible adhesive tape which can be created in multiple flavors and which can provide a unique means of adding flavor to a food product.

Further objectives and advantages of the invention will become apparent from a consideration of the drawings and ensuing description.

### DESCRIPTION OF THE DRAWINGS

FIG. 1 is a perspective view of a tortilla-wrapped food product showing a single small strip of edible adhesive tape holding the tortilla closed.

FIG. 2 is a perspective view of a tortilla-wrapped food product showing a longer strip of edible adhesive tape wrapped all the way around the food product.

FIG. 3 shows how the edible adhesive tape might be formed in a sheet of strips for sale and distribution.

FIG. 4 shows how the edible adhesive tape might be formed as a roll of material for sale and distribution.

FIG. 4A shows how the edible adhesive tape might be packaged in a manner similar to cellophane tape for sale and distribution.

FIG. 5 shows how the edible adhesive tape can be formed in the shape of a company logo for marketing purposes.

FIG. 6 shows the shaped edible adhesive tape of FIG. 5 as it appears when used on a tortilla-wrapped food product.

FIG. 7 shows how an alternate embodiment of the edible adhesive tape in which sheets of the edible adhesive tape are used as flavor layers on a sandwich.

FIG. 8 shows how the edible adhesive tape can be used on the inside surfaces of a pocket bread such as a pita to seal the opening of the pocket.

### DETAILED DESCRIPTION

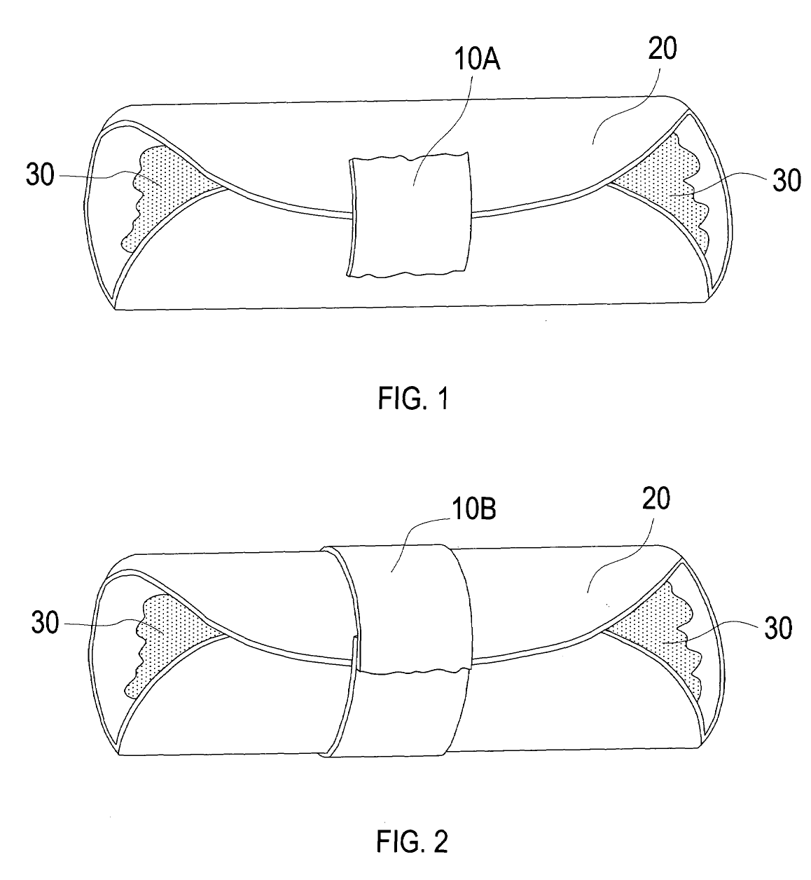

FIG. 1 is a perspective view of an edible adhesive tape being used on a tortilla-wrapped food product, such as a taco or burrito. A food substance 30, such as taco meat, steak, chicken, vegetables, or any other appropriate food is wrapped in a tortilla 20. A small strip of an edible adhesive tape 10A is torn from its package or dispenser and placed across the overlapping portion of the tortilla 20. The edible adhesive tape strip 10A is designed such that it will stick to itself and to other food items such as the tortilla 20. The edible adhesive tape strip 10A adheres to both sides of the tortilla 20, keeping it from falling open. Additional strips of edible adhesive tape 10A could be used to seal one or both ends of the tortilla 20.

FIG. 2 shows an alternate use of the invention. A longer strip of edible adhesive tape 10B is wrapped around the entire tortilla 20 and encased food substance 30. The longer edible adhesive tape strip sticks to itself and creates a band around the tortilla 20 to prevent it from opening during consumption. The longer strip of edible adhesive tape 10B can be wrapped around the tortilla 20 multiple times if desired, further securing the encased food substance, adding additional flavor, or acting as a decoration.

Throughout the drawings and this specification, a variation of the number 10 shall be used as the reference designator when referring to any form of the edible adhesive tape. A letter suffix shall be used after the number 10 to distinguish between the various embodiments of edible adhesive tape. For example, the complete reference designator used to refer to the short strip of edible adhesive tape shown in FIG. 1 is “10A”, and the complete reference designator used to refer to the longer, self-attached strip of edible adhesive tape shown in FIG. 2 is “10B”. Both 10A and 10B refer to the present invention of edible adhesive tape, with the letter suffix used to distinguish between different form factors of the edible adhesive tape. This reference designator scheme (using the number “10” as a base for any form of the edible adhesive tape described herein) is used throughout the text of this specification.

Although a tortilla-wrapped food product is shown in the figures, the edible adhesive tape can be used on any food product as a means of holding the product together, decorating the product, or adding flavor to the product.

The edible adhesive tape can be made by mixing the desired food or food flavoring with gelatin, spreading the product onto a flat surface, and chilling the mixture until firm. The gelatin can be mixed with items such as salsa, guacamole, sour cream, nacho cheese, or taco sauce, or with condiments such as ketchup, mustard, barbecue sauce, or tartar sauce to create the desired flavoring. The foods described herein are meant as examples and any appropriate food or flavoring combination can be used. Once firm, the flavored gelatin product can be cut into strips or different shapes for use in the preparation of food products.

An example recipe for the edible adhesive tape would be to mix one 0.25-ounce package of unflavored gelatin with a cup of salsa to create a salsa-flavored final product. Other foods, sauces, and flavors can be mixed with the gelatin to create the edible adhesive tape.

Although the example recipe provided herein involves the use of gelatin mixed with various foods and flavorings, the invention can be made from any appropriate food or edible substance which can be formed into thin sheets and which provides a sticky or adhesive surface. For example, similar sheets of edible material might be created using a food dehydrator, in which a food or sauce such as salsa is spread out and allowed to dry into a thin sheet.

It may be desirable to create a version of the edible adhesive tape that is not tacky until it is ready to be used on the food product. Edible adhesive tape created using a dehydrating process can be made such that it is relatively tack-free until it has been moistened. A tack-free version of the edible adhesive tape might be more convenient for packaging or storage purposes or for use in commercial operations. The edible adhesive tape could then be “activated” so that it becomes sticky by wiping it with a moist napkin or spraying it with water so that it could be applied to a food product.

The creation of the edible adhesive tape can be automated, such that machines are used to produce rolls or sheets of material in large quantities for commercial distribution. Various form factors and embodiments of the edible adhesive tape are described in the following paragraphs.

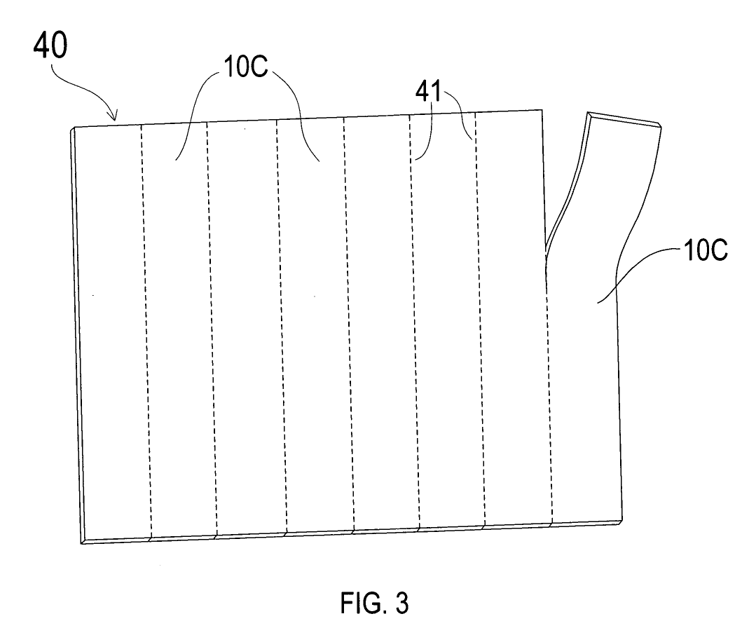

FIG. 3 shows one possible embodiment of a commercially-viable form of the edible adhesive tape product. A sheet of edible adhesive 40 is created using the processes described herein or any appropriate process. Perforations 41 are placed into the edible adhesive sheet 40 such that the edible adhesive sheet 40 can be easily separated into individual strips of edible adhesive tape 10C. These perforations 41 can be made with a wheel cutter (similar to a pizza cutter) that is dragged over the edible adhesive sheet 40 during a manual or automated process, with a press that makes indentations in the edible adhesive sheet 40, formed directly in the edible adhesive sheet 40 during manufacture, or by any appropriate manufacturing process. Packages of the edible adhesive sheets 40 can be sold separately in stores or provided in pre-packaged foods such as sandwiches and tortilla-wrapped items.

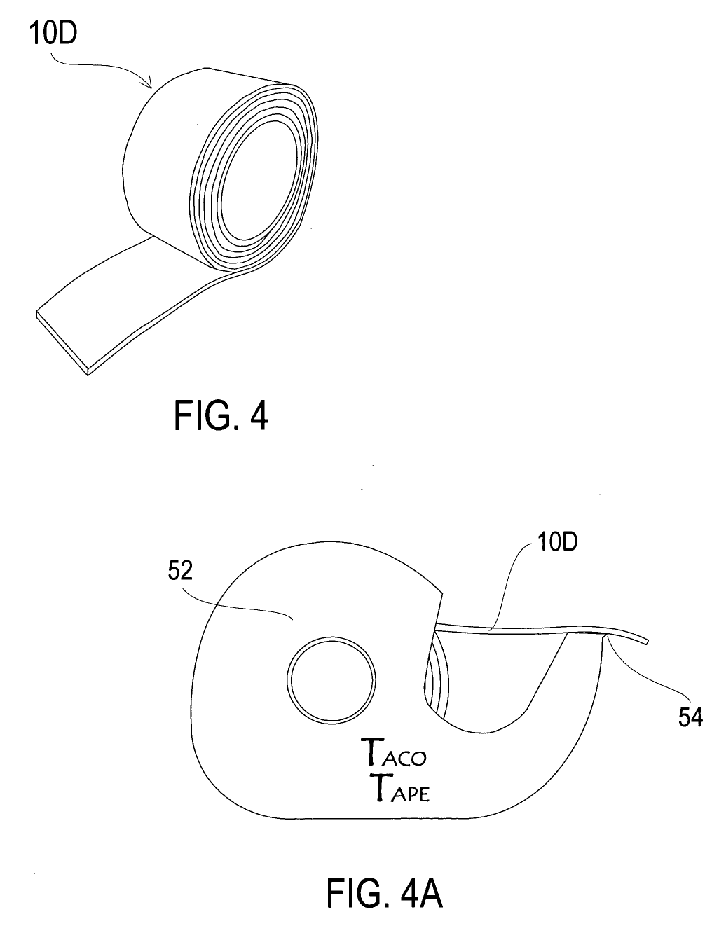

FIG. 4 shows an alternate embodiment of a commercially-viable form of the edible adhesive tape product. A single long strip of edible adhesive tape is packaged and sold as a roll of edible adhesive tape 10D. The roll of edible adhesive tape 10D can be marketed under a name such as “Taco Tape” and sold in dispensers similar to those used to dispense cellophane tape. A company logo, a jingle, or fun information such as trivia questions can be etched, embossed, or sprayed with edible coloring or paint onto the surface of the edible adhesive tape.

FIG. 4A shows one embodiment of such a dispenser in which the roll of edible adhesive tape 10D might be sold. The roll of edible adhesive tape 10D is placed inside of an adhesive tape dispenser 52, which is similar to a cellophane tape dispenser. A cutting surface 54 on the adhesive tape dispenser 52 is provided as a means of cutting a length of tape from the roll of edible adhesive tape 10D for placement on a food product.

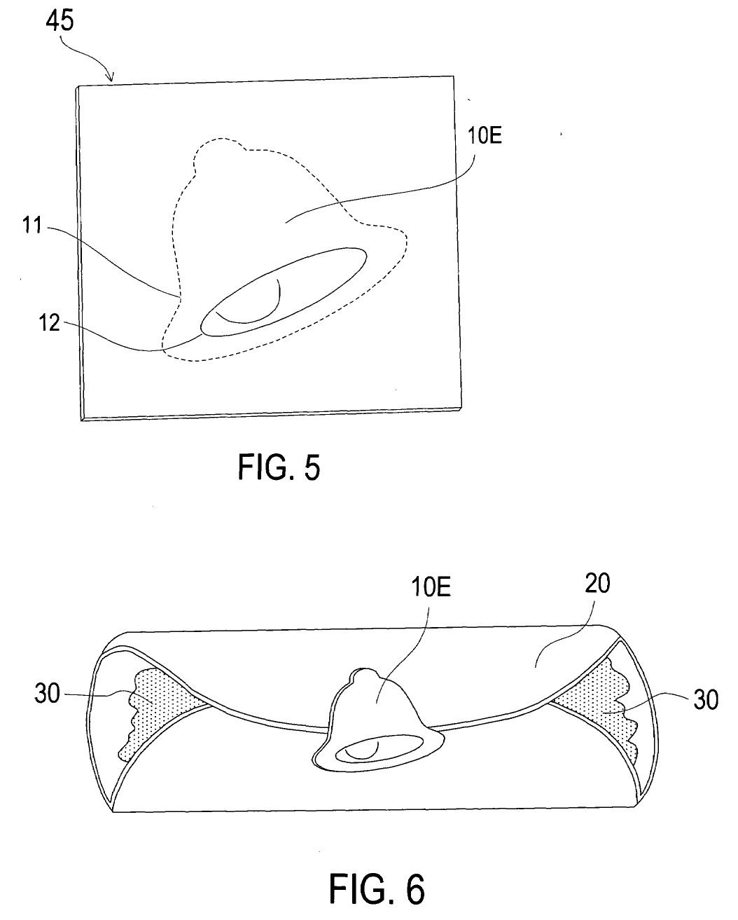

FIG. 5 shows how the edible adhesive tape can be formed in the shape of a company logo for marketing purposes. A company logo shape 10E is formed in the surface of a sheet of edible adhesive tape 45. The outline of the company logo shape 10E is created by making a series of perforations 11 in the sheet of edible adhesive tape 45. These perforations 11 can be made to extend partway through the sheet of edible adhesive tape 45 to allow a consumer to remove the company logo shape 10E for placement on a food product. In an alternate embodiment, the perforations 11 can be made as a solid cut around the company logo shape 10E, such that the remainder of the sheet of edible adhesive tape 45 (the “waste” around the company logo shape 10E) can be discarded. In this alternate embodiment, several company logo shapes 10E could be packaged on a cardboard or paper backing for distribution purposes. Additional features 12 can be embossed in the surface of the company logo shape 10E to provide detail for the interior of the logo. These additional features 12 can be pressed into the sheet of edible adhesive tape 45 with a press, cut with a sharp instrument, etched into the surface, or created with any appropriate manufacturing process. The additional features 12 may also be sprayed or printed onto the surface of the company logo shape 10E using edible spray paints or food colorings. The additional features 12 may also include text, such as a company logo, jingle, or fun information such as trivia questions.

FIG. 6 shows the company logo shape 10E of FIG. 5 as it appears when used on a tortilla-wrapped food product 20. The edible adhesive tape in its embodiment as a company logo shape 10E serves the same function as the short strip of edible adhesive tape 10A in FIG. 1, and only the form factor (shape) is different. The company logo shape 10E will stick to itself and to other food items such as the tortilla 20. The company logo shape 10E adheres to both sides of the tortilla 20, keeping it from falling open and keeping the enclosed food substance 30 from falling out.

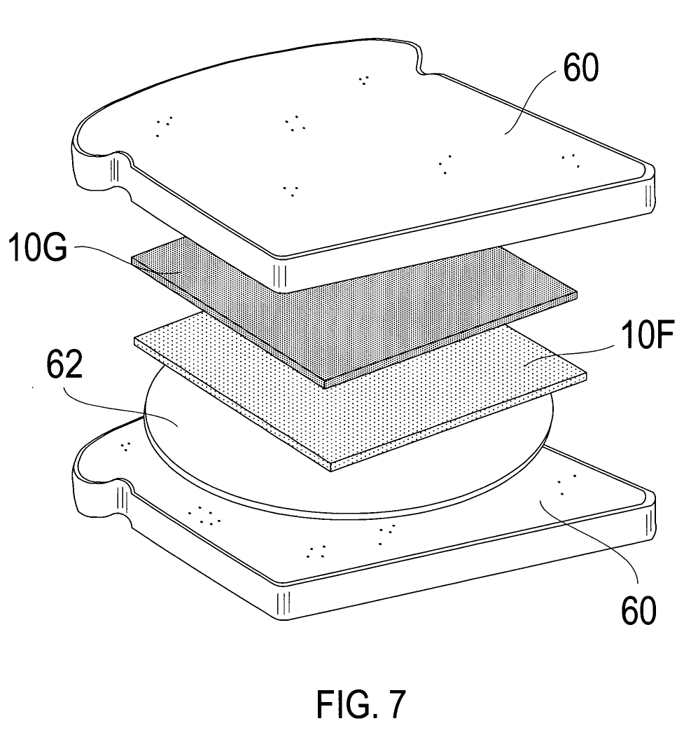

FIG. 7 shows how an alternate embodiment of the edible adhesive tape in which thin sheets or strips of the substance are used as flavor layers on a sandwich or food item. In one example, a mustard-flavored sheet of edible adhesive tape 10F and a ketchup-flavored sheet of edible adhesive tape 10G (“flavor sheets” 10F and 10G) are layered on a sandwich with lunch meat 62 and placed between two slices of bread 60. Flavor sheets 10F and 10G can be used in this manner to add condiments and flavors to a sandwich without adding additional mess. Flavor sheets 10F and 10G can be any appropriate flavor, and any number of flavor sheets can be used in combination to add flavor to a sandwich or food item. The flavor sheets may be manufactured such that they are tacky, to provide the additional function of holding the sandwich together, or they may be manufactured such that they are not tacky and are thus used only for adding flavor. Methods of manufacturing both tacky and non-tacky versions of the edible adhesive tape have been previously described in this specification.

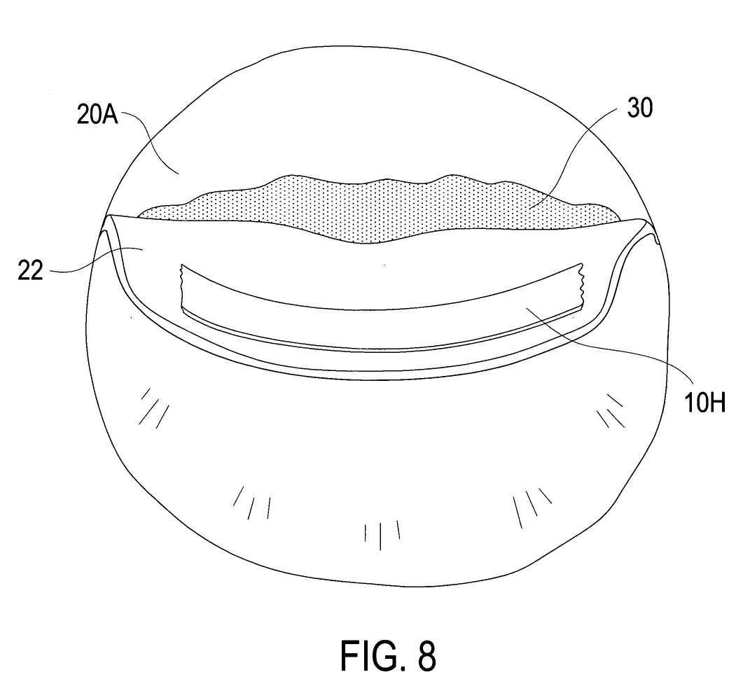

FIG. 8 shows how the edible adhesive tape can be used on the inside surfaces of a pocket bread to seal the opening of the pocket. A long strip of edible adhesive tape 10H is placed on the inside lip 22 of a pocket bread 20A. The pocket bread 20A may be a pita, open flat bread, or any similar bread product formed in the shape of a pocket. The pocket bread 20A is filled with a food substance 30 such as taco meat, steak, chicken, vegetables, or any other appropriate food. The inside lip 22 is folded closed, around the food substance 30, such that the inside lip 22 comes into contact with the back surface of the pocket bread 20A. The strip of edible adhesive tape 10H is sandwiched between the inside lip 22 and the back surface of the pocket bread 20A, forming a seal and encasing the food substance 30 inside the pocket bread 20A. The pocket bread 20A can be distributed with the strip of edible adhesive tape 10H already in place on the inside lip 22. A strip of wax paper or plastic (not shown and not part of the invention) may be placed on the exposed surface of the strip of edible adhesive tape 10H so that it does not stick to any surface until the pocket bread 20A is to be sealed. In an alternate embodiment, a non-tacky version of the strip of edible adhesive tape 10H can be used on the inside lip 22, requiring the strip 10H to be moistened to activate it (make it sticky) before sealing the pocket bread 20A.

Having described the preferred embodiment, it will become apparent that various modifications can be made without departing from the scope of the invention as defined in this document. For example, a long strip of edible adhesive tape could be wrapped around the full length of a submarine sandwich multiple times to keep the sandwich intact, provide a unique look, and to add flavoring. In another embodiment, strips of edible adhesive tape could be composed primarily of an ingredient such as cheese that will melt when placed on a warm sandwich, evenly distributing the ingredient on the sandwich as it melts.

The edible adhesive tape can be sold and distributed in various form factors. In addition to the embodiments shown in the enclosed figures, the edible adhesive tape could be individually wrapped and placed in sandwich packages. Kits with sheets of edible adhesive in multiple flavors could be packaged and sold as a novelty item, allowing people to build flavor combinations by combining layers of different flavors of edible adhesive. For example, a person could combine a hamburger-flavored sheet with cheese-flavored and pickle-flavored sheets to create a cheeseburger-flavored novelty treat, without having an actual cheeseburger.

Food colorings or edible spray paints can be used to add unique colors to the edible adhesive tape, or to add a company logo, jingle, or other form of advertisement or fun information such as riddles, jokes, or trivia questions. A Mexican restaurant such as Taco Bell could distribute sheets or strips of the edible adhesive tape with their logo printed on them as part of a marketing campaign.

What is claimed:

1. An edible adhesive tape which is applied to a food item wherein the edible adhesive tape prevents the food item from falling apart while being consumed.

2. The edible adhesive tape of claim 1 wherein the food item to which the tape is applied is selected from the group taco, burrito, enchilada, tortilla, sandwich, pita, or flatbread.

3. The edible adhesive tape of claim 2 wherein the edible adhesive tape is applied by wrapping it around at least a portion of the food item.

4. The edible adhesive tape of claim 3 wherein the at least a portion of the food item is the entire outer diameter of the food item, wherein a first end of the edible adhesive tape overlaps and adheres to a second end of the edible adhesive tape.

5. The edible adhesive tape of claim 3 wherein the at least a portion of the food item is less than the entire outer diameter of the food item, wherein the edible adhesive tape is placed over an opening in the food item to prevent the food item from opening further, wherein the edible adhesive tape adheres to the surfaces of the food item on either side of the opening.

6. The edible adhesive tape of claim 2 wherein the edible adhesive tape is applied by placing it between at least two layers of the food item.

7. The edible adhesive tape of claim 1 wherein the form factor of the edible adhesive tape is a rectangular sheet of material.

8. The edible adhesive tape of claim 7 wherein the rectangular sheet of material is subdivided into strips which can be separated for application to the food item.

9. The edible adhesive tape of claim 1 wherein the form of the edible adhesive tape is a roll of edible material.

10. The edible adhesive tape of claim 9 wherein the roll of edible material is dispensed in a package resembling a cellophane tape dispenser.

11. An edible adhesive tape which is applied to a food item as a decoration.

12. The edible adhesive tape of claim 11 in which the edible adhesive tape is a decoration in the shape of a company logo.

13. The edible adhesive tape of claim 11 in which the edible adhesive tape is wrapped at least once around the food item for decorative purposes.

14. A sheet of flavored edible material which can be placed in a food item as a means of adding additional flavor to the food item.

15. The sheet of flavored edible material of claim 14 wherein the sheet of flavored edible material has a sticky exterior surface, wherein the sticky exterior surface provides a means of holding the food item together while it is being consumed.

16. The sheet of flavored edible material of claim 14 wherein the flavored edible material will melt when heated.

17. The sheet of flavored edible material of claim 14 wherein the food item is selected from the group taco, burrito, enchilada, tortilla, sandwich, pita, or flatbread.

18. The sheet of flavored edible material of claim 14 wherein the food item is a second sheet of flavored edible material, wherein the second sheet of flavored edible material has a different flavor from the sheet of flavored edible material.
